(19) United States
(12) Patent Application Publication
(10) Pub. No.: US 2016/0270493 A1
(43) Pub. Date: Sep. 22, 2016

(54) DERMAL ANCHOR BASE

(71) Applicant: Intrinsic Body Inc., San Francisco, CA (US)

(72) Inventor: Wickert Beasley, San Francisco, CA (US)

(21) Appl. No.: 14/659,593

(22) Filed: Mar. 16, 2015

(51) Int. Cl. A44C 15/00; B25B 9/02

(52) U.S. Cl. CPC A44C 15/0035; B25B 9/02

(57) ABSTRACT

A dermal anchor system for body jewelry is disclosed. The system allows for improved installation and removal of dermal anchor body jewelry by allowing for application of an external force to counteract tightening and loosening forces related to the jewelry. The system includes a hand tool that interacts with an engineered receiving post of a dermal anchor base. The hand tool allows for installation and/or removal of decorative top ends to the receiving post while preventing movement of the dermal anchor base. Torque is externally controlled without disturbing body tissues surrounding the dermal anchor base.

### BACKGROUND OF THE INVENTION

1. Field of the Invention

The present application generally relates to decorative body jewelry piercing. More specifically, the present invention relates to a dermal anchor base that might be used for decorative body jewelry piercings that do not protrude through the skin.

2. Description of the Related Art

Body piercing is a form of body modification that involves puncturing or cutting a part of the human body, thereby creating an opening in or through which jewelry may be worn. Ample evidence exists documenting the practice of body piercing in various forms by both sexes since ancient times and throughout the world. For example, the practice of ear and nose piercing has been confirmed by mummified remains from as early as 1500 BC. Lip and tongue piercings have been thoroughly documented in early African tribal cultures. Genital piercing has been identified in the Indian sub-continent as occurring as early as 320 to 550 CE.

The practice of body piercing has waxed and waned in Western culture throughout the years. Body piercing experienced an increased subcultural popularity in the 1970s and has come so far as to be considered mainstream since the 1990s. With the rise in mainstream acceptance of body modification, there has been a corresponding interest and need for the adoption and use of safe body piercing techniques, tools, and materials.

Of particular interest—and the focus of the present application—are those decorative body jewelries that utilize a dermal anchor base. A dermal anchor base may be utilized to selectively decorate parts of the human body. A dermal anchor base typically includes a body anchor that is secured under the skin. A portion of the base then protrudes through the skin by way of a receiving post. The receiving post then connectively couples to one or more decorative body jewelries, usually through the use of a threaded male-female configuration.

A dermal anchor base for decorative body jewelry is typically utilized in those instances where both ends of a piece of body jewelry do not protrude through the skin. A consequence of such an arrangement is that only one part—the top end of the jewelry—is exposed, while the base remains enclosed in the body tissue. A post, which is an integrated feature of the base, protrudes through the skin and attaches to the corresponding threaded top end. This is the typical design available on the market for dermal anchor body jewelry

Problems exist with respect to the use of threaded dermal anchor bodies with respect to the rotation of the base part of the jewelry when tightening or loosening the corresponding exposed top end. These problems typically arise as a result of tightening and/or loosening forces that are transmitted from one part to the other—usually from the top to the base. Existing dermal anchor designs typically rely on the base of the dermal anchor to develop a reaction force against body tissues. This force counteracts a tightening force in the case of installation and a loosening force in the vent of removal. Surrounding body tissues are often manipulated in order to prevent movement of the base, but such manipulation can cause body tissues to be disturbed, damaged, or even infected, which might result in the need for the removal of the base in its entirety.

Other exemplary but ultimately unsatisfactory solutions have involved the use of interchangeable gems. A gem magnetically attaches to the top end of the base, thereby avoiding the need for disassembly of the threaded top end. A magnetic solution often proves unsatisfactory, however, in that the magnetic force is often insufficient to maintain the placement of the gem resulting in loss of the same. Magnetic solutions, too, often fail to allow for the use of alternative jewelry types, thereby limiting any variety solely to gem color, shape, and size.

A further yet equally unsatisfactory solution has involved the use of a suction force. But like the use of a magnetic solution, the suction often fails, resulting in the loss of the corresponding piece of jewelry. Suction-based solutions are also limited in that the strength of the suction force limits the size and especially the shape of any corresponding piece of jewelry.

There is a need in the art for a body jewelry system that solves the problem of assembly and disassembly by rotation of a hand tool. Such a system would include an engineered tool interface as a part of the dermal anchor base. Such a system would allow for greater freedom and variety with respect to a corresponding piece of jewelry that is coupled to the base, including but not limited to the shape and size of the same.

### BRIEF DESCRIPTION OF THE DRAWINGS

FIG. 1 illustrates an exploded view and assembly view of the dermal anchor base, tool, and generic threaded top end.

FIG. 2 illustrates a series of dermal anchor bases with a plate and engineered post.

FIG. 3A illustrates a tool for installation and removal of body jewelry in accordance with the present invention.

FIG. 3B illustrates the tool contacting the post with sufficient tolerance and tightness of fit such that it transmits a counteracting hand force to the base while tightening or loosening the threaded top end.

FIG. 4 illustrates the counteracting forces encountered during the act of jewelry installation.

FIG. 5 illustrates the counteracting forces encountered during the act of jewelry removal.

### SUMMARY OF THE CLAIMED INVENTION

In an embodiment of the present invention, what is claimed is a dermal anchor system. The system includes a dermal anchor base with a receiving post. The receiving post protrudes through the skin of a person hosting the dermal anchor base. The system also includes a hand tool. The hand tool applies external force that counteracts installation and removal forces that are generated during an interaction with a jewelry component at the receiving post.

A further embodiment of the claimed invention applies the external force concentrically with respect to an axis of the receiving post. This application of force is the result of a mechanical fit between the receiving post and the hand tool.

In a still further embodiment of the presently claimed invention, the mechanical fit of the hand tool with respect to the receiving post includes a corresponding tolerance and tightness that allows for the application of the external force as a result of a shaping of the tool.

In a final claimed embodiment, the shaping of the tool includes the thickness of the hand tool. As a result of the thickness shaping, the hand tool allows clearance between the installed top end of the receiving post and the surface of the skin of the host of the dermal anchor base.

### DETAILED DESCRIPTION

A dermal anchor system for body jewelry is disclosed. The system allows for improved installation and removal of dermal anchor body jewelry by allowing for application of an external force to counteract tightening and loosening forces related to the jewelry. The system includes a hand tool that interacts with an engineered receiving post of a dermal anchor base. The hand tool allows for installation and/or removal of decorative top ends to the receiving post while preventing movement of the dermal anchor base. Torque is externally controlled without disturbing body tissues surrounding the dermal anchor base.

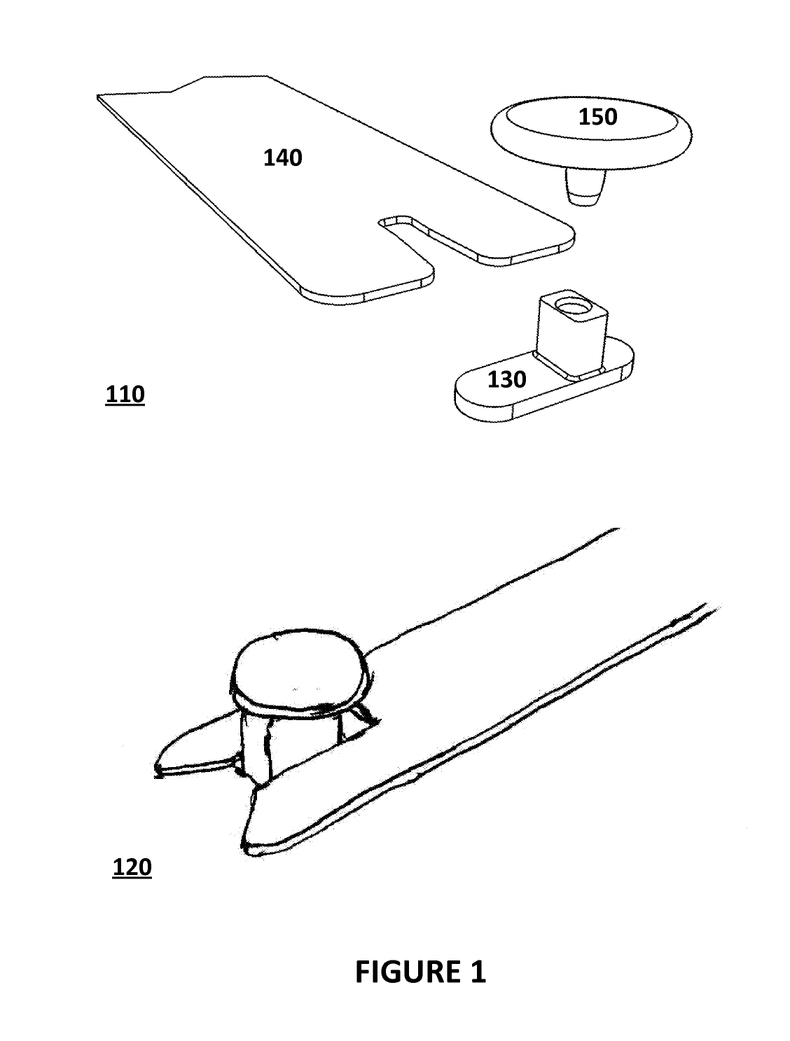

FIG. 1 illustrates an exploded view 110 and assembly view 120 of the dermal anchor base 130, tool 140, and generic threaded top end 150. The exploded view 110 of FIG. 1 illustrates an asymmetrical dermal anchor base where the post of the base is not centered (i.e., an asymmetrical configuration).

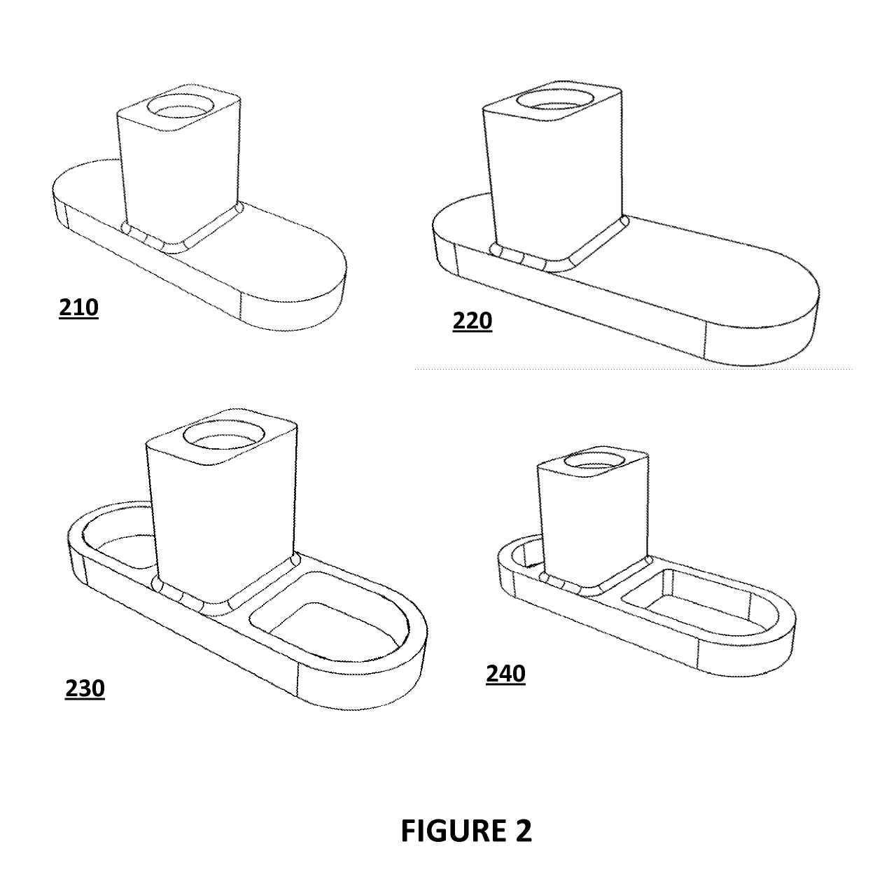

FIG. 2 illustrates a series of dermal anchor bases with a plate and engineered post. The dermal anchor base includes a flat plate shaped portion that remains enclosed in the body tissue of a host of the base (i.e., the individual wearing the jewelry). The base includes a specifically engineered post that protrudes from the skin.

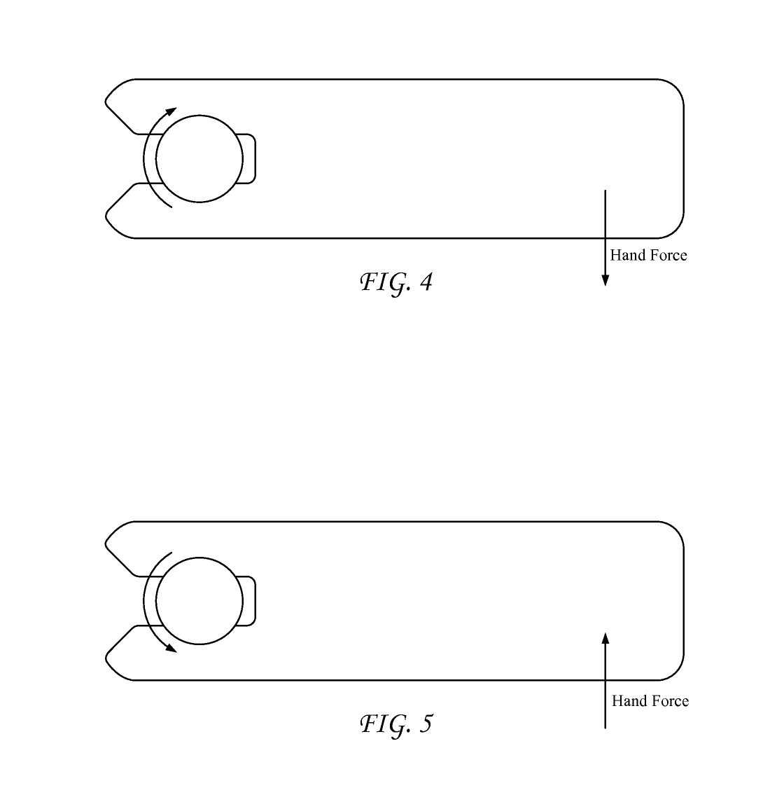

The positioning of the post on base 210 as shown in FIG. 2 is symmetrical with respect to the closed anchor base. The positioning of the post relative the base as illustrated with respect to closed anchor base 220 is asymmetrical; this design is similar to that shown in FIG. 1 (130). FIG. 2 also illustrates a base 230 that includes an open anchor base (i.e., with holes) and a symmetrically positioned post. The fourth and final base illustrated in FIG. 4 is base 240. Base 240 is also open (i.e., includes holes) but the post is asymmetrically positioned. While the shape of the plate may vary without deviating from the overall spirit of the presently disclosed invention, the post is specifically engineered. The engineering of the post allows for acceptance of the hand tool with sufficient tolerance and tightness in order to transmit an externally applied force while preventing movement of the base during jewelry installation or removal.

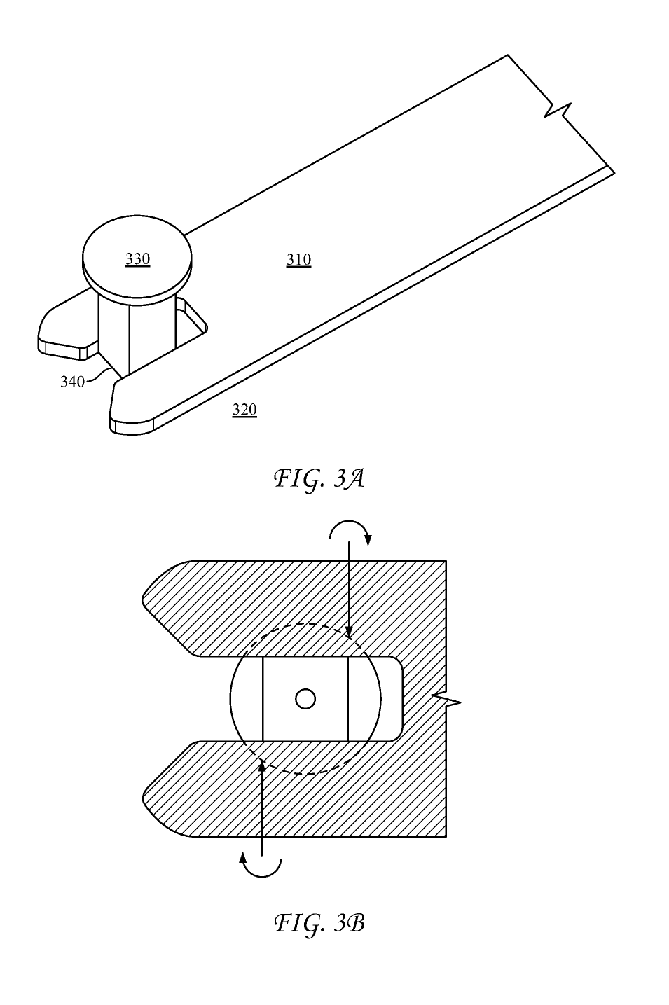

FIG. 3A illustrates a tool for installation and removal of body jewelry in accordance with the present invention. The dermal anchor base hand tool 310 of FIG. 3 is shaped to fit between the surface of the skin (320) and the top end 330 of the receiving post 340. FIG. 3B illustrates the tool contacting the post with sufficient tolerance and tightness of fit such that it transmits a counteracting hand force to the base while tightening or loosening the threaded top end.

The interface utilizes a mechanical fit between the base and tool. This fit allows a coupling force to be applied concentrically with the axis of the post. The applied coupling force from use of the hand tool is sufficient to counteract the torque generated by a tightening action as illustrated in FIG. 4. Said force is likewise sufficient to counteract a loosening force as illustrated in FIG. 5.

FIG. 4 illustrates the counteracting forces encountered during the act of jewelry installation. More specifically, FIG. 4 illustrates a cross-section view of the interface between the dermal anchor base and hand tool. Shown in FIG. 4 is the torque applied to the top end of the receiving post, the coupling force at the interface of the dermal base and hand tool, and the hand force that is reactive against the load path of the aforementioned torque and coupling force.

FIG. 5 illustrates the counteracting forces encountered during the act of jewelry removal. Similar to FIG. 4, FIG. 5 specifically illustrates a cross-section view of the interface between the dermal anchor base and hand tool. Shown in FIG. 5 is torque applies to the top end of the receiving post, a coupling force applied at the interface of the dermal anchor base and hand tool, and a reactive hand force resulting from the load path of the top end torque and coupling force during the removal process.

As described above, the present dermal anchor base and hand tool system allows an external force to be applied to counteract forces generated during installation and removal of top ends from dermal anchors. The mechanical fit between the base post and tool allows a force couple to be applied concentrically with the axis of the post. The hand tool is shaped to achieve the mechanical fit to the base post with sufficient tolerance and tightness of fit to transmit a counteracting hand force and has a thickness small enough to allow clearance between the installed top end and the surface of the skin.

The result is a system that solves the problem of assembly and disassembly by rotation of a hand tool. The presently described system allows for greater freedom and variety with respect to a corresponding piece of jewelry that is coupled to the base, including but not limited to the shape and size of the same. More importantly, however, is that the presently disclosed system improves the installation and removal techniques for dermal anchor body jewelry without regard to a particular source of jewelry.

The above-described embodiments are illustrative of the spirit of the present invention. The aforementioned system may be embodied in other specific forms without departing from the intended spirit of the same. In that regard, the described embodiment is to be considered illustrative and not restrictive other than with respect to the appended claims. It will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A dermal anchor system, the system comprising:
a dermal anchor base having a receiving post that protrudes through the skin of a person hosting the dermal anchor base; and
a hand tool, wherein the hand tool applies external force that counteracts installation and removal forces generated during an interaction with a jewelry component at the receiving post.

2. The system of claim 1, wherein the external force is applied concentrically with respect to an axis of the receiving post as a result of a mechanical fit between the receiving post and the hand tool.

3. The system of claim 2, where the mechanical fit of the hand tool with respect to the receiving post includes a corresponding tolerance and tightness to apply the external force as a result of a shaping of the tool.

4. The system of claim 3, wherein the shaping of the tool includes the thickness of the hand tool whereby the hand tool allows clearance between the installed top end of the receiving post and the surface of the skin of the host of the dermal anchor base.
